(19) United States
(12) Patent Application Publication
(10) Pub. No.: US 2022/0416318 A1
(43) Pub. Date: Dec. 29, 2022

(54) In-Vehicle Power Source Control Apparatus and In-Vehicle Power Source Apparatus

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Hikaru Suzuki, Yokkaichi-shi, Mie (JP)

(21) Appl. No.: 17/756,199

(22) PCT Filed: Nov. 5, 2020
(86) PCT No.: PCT/JP2020/041408

§ 371 Date: May 19, 2022

(30) Foreign Application Priority Data
Nov. 22, 2019 (JP) 2019-211207

(51) Int. Cl. H01M 10/44; H02J 7/00; B60R 16/033; H01M 10/48

(52) U.S. Cl. CPC H01M 10/44; H02J 7/007182; H02J 7/0047; B60R 16/033; H01M 10/48; H01M 2220/20

(57) ABSTRACT

An in-vehicle power source control apparatus includes a discharge circuit that performs a backup operation of supplying power from a power storage unit to a first load and a second load, a control unit that causes the discharge circuit to perform a backup operation when a backup condition is met, and a voltage detection unit that detects an output voltage of the power storage unit. When an output voltage of the power storage unit falls below a threshold voltage while power supply to the second load is in a stopped state after the backup operation is started, the control unit prohibits the backup operation from being performed on the second load.

### CROSS-REFERENCE TO RELATED APPLICATIONS

This application is the U.S. national stage of PCT/JP2020/041408 filed on Nov. 5, 2020, which claims priority of Japanese Patent Application No. JP 2019-211207 filed on Nov. 22, 2019, the contents of which are incorporated herein.

### TECHNICAL FIELD

The present disclosure relates to an in-vehicle power source control apparatus and an in-vehicle power source apparatus.

### BACKGROUND

There is a desire to simplify the configuration of a power storage element in order to reduce the size and cost of a redundant in-vehicle power source apparatus. In view of this, in order to obtain a minimum necessary configuration of a power storage element in a power source apparatus, a configuration is required in which the charge state of the power storage element can be accurately recognized.

A power storage element management apparatus of JP 2016-166864A, for example, is configured to recognize the charge state of a power storage element by obtaining the SOC (State Of Charge) thereof using a current integration method and an OCV (Open Circuit Voltage) method. The current integration method is a method for determining a SOC of a power storage element through time integration of a current flowing through the power storage element. The OCV method is a method for determining a SOC based on the V-SOC correlation between the voltage and the charge state of a power storage element. The power storage element management apparatus sections the V-SOC correlation into a plurality of SOC regions, namely a first SOC region (region that includes an SOC determined using the current integration method) and a second SOC region (region (that includes an SOC) determined by the OCV method). In a case where the first SOC region and the second SOC region are different from each other, the power storage element management apparatus uses a predetermined value in the second SOC region as an inferred SOC value.

Disclosure [0005] In a configuration that uses an ordinary method for inferring a charge state as is the case with the power storage element management apparatus of JP 2016-166864A, a method for determining the degree how much an output voltage of a power storage element has decreased, in order to recognize a change in the power supply ability of the power storage element is conceivable, for example. However, when a load (in-vehicle apparatus) is operating, the output voltage of the power storage element changes due to the operation of the load. As a result of the output voltage of the power storage element depending on the operation of the load in this manner, a problem arises in that it is not possible to accurately recognize the power supply ability of the power storage element.

In view of this, the present disclosure aims to provide a technique that makes it possible to more accurately recognize the power supply ability of a power storage unit and reliably save the ability to supply power to a first load while preventing a backup operation from being excessively prohibited.

### SUMMARY

An in-vehicle power source control apparatus that is one mode of the present disclosure is an in-vehicle power source control apparatus that controls an in-vehicle power source system that includes a power storage unit and a power source unit configured to supply power to a first load and a second load, the in-vehicle power source control apparatus including: a discharge circuit configured to perform a backup operation of supplying power from the power storage unit to the first load and the second load; a control unit configured to cause the discharge circuit to perform the backup operation when a backup condition is met; and a voltage detection unit configured to detect an output voltage of the power storage unit, and when an output voltage of the power storage unit falls below a threshold voltage while power supply to the second load is in a stopped state or a predetermined decrease state after the backup operation is started, the control unit prohibits the backup operation from being performed on the second load.

An in-vehicle power source apparatus that is one aspect of the present disclosure includes: the in-vehicle power source control apparatus; and the power storage unit.

### Advantageous Effects

According to the present disclosure, it is possible to more accurately recognize the power supply ability of a power storage unit and reliably save the ability to supply power to a first load while preventing a backup operation from being excessively prohibited.

### BRIEF DESCRIPTION OF DRAWINGS

FIG. 1 is a block diagram schematically illustrating an in-vehicle power source system that includes an in-vehicle power source control apparatus according to a first embodiment.

FIG. 2 is a flowchart illustrating a flow of prohibition control executed by a control unit according to the first embodiment for prohibiting a backup operation from being performed on a second load.

FIG. 3 is a timing chart showing time changes in detected values that are detected by the in-vehicle power source control apparatus according to the first embodiment.

FIG. 4 is a timing chart showing time changes in detected values that are detected by the in-vehicle power source control apparatus according to the first embodiment, in a state that is different from that in FIG. 3.

FIG. 5 is a timing chart showing time changes in detected values that are detected by an in-vehicle power source control apparatus in a comparative example.

### DETAILED DESCRIPTION OF PREFERRED EMBODIMENTS

First, embodiments of the present disclosure will be listed and described.

An in-vehicle power source control apparatus that is an example of the present disclosure is an in-vehicle power source control apparatus that controls an in-vehicle power source system that includes a power storage unit and a power supply unit configured to supply power to a first load and a second load, the in-vehicle power source control apparatus including: a discharge circuit configured to perform a backup operation of supplying power from the power storage unit to the first load and the second load; a control unit configured to cause the discharge circuit to perform the backup operation when a backup condition is met; and a voltage detection unit configured to detect an output voltage of the power storage unit, and, when an output voltage of the power storage unit falls below a threshold voltage while power supply to the second load is in a stopped state or a predetermined decrease state after the backup operation is started, the control unit prohibits the backup operation from being performed on the second load.

In this manner, the in-vehicle power source control apparatus according to the present disclosure can more accurately recognize the power supply ability of the power storage unit, by comparing the output voltage of the power storage unit obtained in a state where operation of the second load has little or no influence, with a threshold voltage. When there is a steady decline in the power supply ability of the power storage unit, the control unit can prohibit a backup operation, thus suppressing a further decline, and save the ability to supply power to the first load. On the other hand, a configuration can be adopted in which, even when the voltage temporarily decreases, the control unit does not prohibit a backup operation provided that the voltage does not decrease in a stopped state or decrease state. Accordingly, the control unit can prevent a backup operation from being excessively prohibited.

A power detection unit that detects power that is supplied to the second load side may be provided on a path between the power storage unit and the second load. When power that is detected by the power detection unit falls below a threshold power after the backup operation is started, the control unit may prohibit the backup operation from being performed on the second load.

With such a configuration, the control unit can recognize power that can be supplied to the second load side by the power storage unit, by comparing power that is detected by the power detection unit with the threshold power. Accordingly, even when power supply to the second load is not in a stopped state or a predetermined decrease state and it is not possible to recognize the output voltage of the power storage unit, the control unit can detect a decline state of the power supply ability from the power storage unit to the second load side. When there is a steady decline in the power supply ability of the power storage unit, the control unit can prohibit the backup operation, and thus suppress a further decline, and save the power supply ability for the first load. On the other hand, by adopting a configuration in which the backup operation is not prohibited if the power supply ability of the power storage unit is secured, the control unit can prevent the backup operation from being excessively prohibited.

A current detection unit that detects a current flowing through the second load may be provided. When a current that is detected by the current detection unit is smaller than a threshold current, and the output voltage of the power storage unit falls below a threshold voltage, the control unit may prohibit the backup operation from being performed on the second load.

With such a configuration, when a current flowing through the second load is smaller than the threshold current, the control unit can infer that the second load is in a stopped state or a predetermined decrease state. When the current that is detected by the current detection unit is smaller than the threshold current, the control unit compares the output voltage of the power storage unit with the threshold voltage. Accordingly, the control unit can more accurately recognize the power supply ability of the power storage unit in a state where operation of the second load has little or no influence.

After the backup operation is started and the backup operation is prohibited from being performed on the second load, the control unit may maintain a prohibited state until the backup operation ends.

With such a configuration, the control unit prohibits the backup operation from being performed on the second load and thereby does not need to supply power to the second load any longer. Therefore, in place of not supplying power after the prohibiting the backup operation from being performed on the second load, the control unit can increase the power supply ability before prohibiting the backup operation from being performed on the second load.

Specific examples of an in-vehicle power source control apparatus and an in-vehicle power source apparatus according to the present disclosure will be described below with reference to the drawings. Note that the present disclosure is not limited to illustrations of these, but is indicated by the claims, and is intended to include all modifications that are within the meanings and the scope that are equivalent to those of the claims.

### First Embodiment

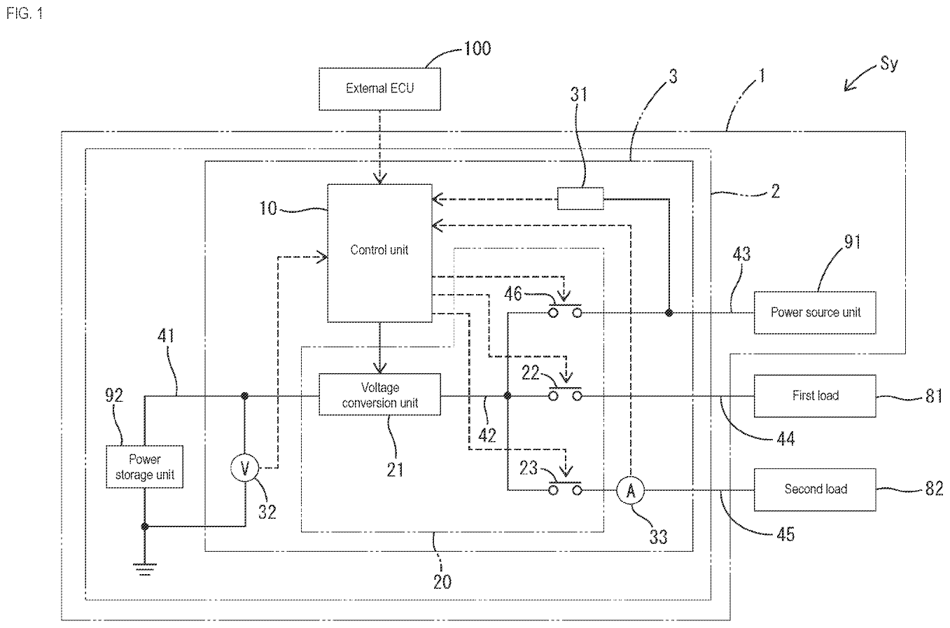

FIG. 1 discloses a vehicle system Sy that includes a vehicle power source system 1 (hereinafter, also referred to as a “power source system 1”), and a first load 81 and a second load 82 that are supplied with power from the vehicle power source system 1. The vehicle power source system 1 shown in FIG. 1 includes a power source unit 91 that functions as a main power source, a power storage unit 92 that functions as a backup power source, and a vehicle power source control apparatus 3 (hereinafter, also referred to as the “control apparatus 3”). The vehicle system Sy is configured as a system in which the power source system 1 can supply power to the first load 81 and the second load 82 and is configured as a system in which a backup operation performed at the time of a failure can be controlled by the control apparatus 3.

The first load 81 and the second load 82 are various electrical components implemented in a vehicle. The first load 81 is, for example, an electrical component that operates when a specific condition is met. The first load 81 is, for example, an electrical component that operates as prescribed, based on an operation instruction signal that is transmitted from an external ECU 100 (signal that is transmitted when a predetermined condition is met). That is to say, the first load 81 operates for a certain operation time at a certain power consumption. The second load 82 is an electrical component that does not operate as prescribed, for example. That is to say, the second load 82 is an electrical component for which an operation timing is not defined, and operates in response to an operation performed by the user. The first load 81 is electrically connected to a fourth conductive path 44, and is supplied with power from the power source unit 91 or the power storage unit 92 via the fourth conductive path 44. The second load 82 is electrically connected to a fifth conductive path 45, and is supplied with power from the power source unit 91 or the power storage unit 92 via the fifth conductive path 45.

The power source unit 91 is a power source unit implemented in a vehicle, and functions as a main power source for supplying power to various targets. The power source unit 91 is configured as an in-vehicle battery such as a lead battery. A high-potential terminal of the power source unit 91 is electrically connected to a third conductive path 43 and applies a predetermined output voltage to the third conductive path 43. Note that, in FIG. 1, a fuse, an ignition switch, and the like are omitted. A switch 46 is provided on the third conductive path 43. The switch 46 may be a semiconductor switch element such as an FET or a bipolar transistor, or may also be a mechanical relay. The switch 46 performs an on/off operation based on an instruction signal from a control unit 10. When on, the switch 46 electrically connects the power source unit 91, a second conductive path 42, the fourth conductive path 44, and the fifth conductive path 45.

The power storage unit 92 is constituted by power storage means such as an electric double layer capacitor (EDLC). The power storage unit 92 is electrically connected to a discharge circuit 20 via a first conductive path 41, is charged by the discharge circuit 20, and is discharged by the discharge circuit 20. The power storage unit 92 applies an output voltage that corresponds to the degree of charge thereof to the first conductive path 41. This power storage unit 92 functions as a backup power source, and operates as a power supply source at least when power supply from the power source unit 91 is interrupted. In this configuration, a vehicle power source apparatus 2 (hereinafter, also referred to as a “power source apparatus 2”) is constituted by the power storage unit 92 and the control apparatus 3 to be described later.

In a normal state, namely when there is no decline in power supply from the power source unit 91, the output voltage of the power source unit 91 of the power source system 1 is applied to the third conductive path 43 that is a power line, and power is supplied to various electrical components from the power source unit 91 via the third conductive path 43. Note that the output voltage of the power source unit 91 represents an inter-terminal voltage between a high potential terminal and a low potential terminal of the power source unit 91.

The control apparatus 3 includes the control unit 10, the discharge circuit 20, a voltage detection unit 31, a voltage detection unit 32, a current detection unit 33, and the like.

The discharge circuit 20 performs a backup operation of supplying power from the power storage unit 92 to at least one of the first load 81 and the second load 82. The discharge circuit 20 is disposed between the power source unit 91 and the power storage unit 92. The discharge circuit 20 includes a voltage conversion unit 21 and switches 22 and 23. The voltage conversion unit 21 is disposed between the first conductive path (conductive path on the power storage unit side) 41 and the second conductive path (conductive path on the power source unit side) 42. The voltage conversion unit 21 is configured as a step-up/down DC-DC converter, and is configured to step up or down a DC voltage applied to one of the first conductive path 41 and the second conductive path 42, and output the resulting voltage to the other conductive path. Specifically, the voltage conversion unit 21 may step up or down the voltage of the first conductive path 41 electrically connected to the power storage unit 92, and perform a voltage conversion operation of applying a target voltage (voltage instructed by the external ECU 100) to the second conductive path 42. The voltage conversion unit 21 may step up or down the voltage of the second conductive path 42 that is electrically connected to the power source unit 91, and perform a voltage conversion operation of applying a target voltage to the first conductive path 41. The control unit 10 gives, to the voltage conversion unit 21, a discharge instruction signal instructing that the power storage unit 92 is to be discharged or a discharge stop signal instructing that discharge of the power storage unit 92 is to be stopped. The voltage conversion unit 21 performs a discharge operation of causing a discharge current to flow through the second conductive path 42 from the power storage unit 92 and a blocking operation of blocking a discharge current, in accordance with a signal from the control unit 10. When a discharge instruction signal instructing that the power storage unit 92 is to be discharged is received from the control unit 10, the voltage conversion unit 21 performs a voltage step-up operation or a voltage step-down operation, using, as an input voltage, the voltage of the first conductive path 41 to which the output voltage of the power storage unit 92 is applied. The voltage conversion unit 21 then performs a discharge operation of applying a target voltage set for the second conductive path 42 on the output side (specifically, a discharge operation of applying a target voltage set for the second conductive path 42 by the control unit 10). When a discharge stop signal for the power storage unit 92 is received from the control unit 10, the voltage conversion unit 21 stops such a discharge operation, and performs a blocking operation such that the first conductive path 41 and the second conductive path 42 are electrically disconnected.

The control unit 10 gives, to the voltage conversion unit 21, a discharge instruction signal instructing that power be discharged from the power storage unit 92 to the power source unit 91, or a discharge stop signal instructing that the discharge of power from the power source unit 91 to the power storage unit 92 be stopped. The voltage conversion unit 21 performs a discharge operation for causing a discharge current to flow from the second conductive path 42 to the first conductive path 41 and a blocking operation for blocking the discharge current in accordance with a signal from the control unit 10. When a discharge instruction signal for the power source unit 91 is received from the control unit 10, the voltage conversion unit 21 performs a voltage step-up operation or a step-down operation using, as an input voltage, the voltage of the second conductive path 42 to which the output voltage of the power source unit 91 is applied. The voltage conversion unit 21 then performs a discharge operation (specifically, a discharge operation of applying a target voltage set by the control unit 10 to the first conductive path 41) such that a target voltage set for the first conductive path 41 on the output side is applied. When a discharge stop signal for the power source unit 91 is received from the control unit 10, the voltage conversion unit 21 stops such a discharge operation, and performs a blocking operation such that the second conductive path 42 and the first conductive path 41 are electrically disconnected.

The switches 22 and 23 are respectively provided on the fourth conductive path 44 and the fifth conductive path 45. Each of the switches 22 and 23 may be a semiconductor switch element such as an FET or a bipolar transistor, or may also be a mechanical relay. The switches 22 and 23 perform an on/off operation based on an instruction signal from the control unit 10. When on, the switch 22 electrically connects the first load 81 to the second conductive path 42 and the third conductive path 43. When the switch 22 is on while the switch 46 is on, an output current that is output from the power source unit 91 may be supplied to the first load 81. When the switch 22 is on while the voltage conversion unit 21 is performing a discharge operation, an output current (discharge current) that is output from the voltage conversion unit 21 can be supplied to the first load 81.

When on, the switch 23 electrically connects the second load 82 and the second conductive path 42. When the switch 23 is on while the switch 46 is on, an output current that is output from the power source unit 91 can be supplied to the second load 82. When the switch 23 is on while the voltage conversion unit 21 is performing a discharge operation, an output current (discharge current) that is output from the voltage conversion unit 21 can be supplied to the second load 82.

The voltage detection unit 31 is provided on the third conductive path 43. The voltage detection unit 31 is configured as a voltage detection circuit, and detects a voltage applied to the third conductive path 43. The voltage detection unit 31 detects the voltage on the third conductive path 43, and inputs the detected voltage as a detected value to the control unit 10. Note that a configuration may be adopted in which the voltage detection unit 31 causes a voltage-dividing circuit to divide the voltage on the third conductive path 43 and detects the divided voltages, and input the divided voltages as detected values to the control unit 10.

The voltage detection unit 32 is provided on the first conductive path 41. The voltage detection unit 32 detects a voltage applied to the first conductive path 41 (an output voltage of the power storage unit 92), and inputs the detected voltage as a detected value to the control unit 10. Here, the voltage conversion unit 21 includes a current detection circuit (not illustrated), and is configured to detect a current flowing through the first conductive path 41 to the second load 82 side. The control unit 10 to be described later calculates power on the first conductive path 41 based on a voltage detected by the voltage detection unit 32 and a current detected by a current detection circuit of the voltage conversion unit 21. Note that the voltage detection unit 32, the voltage conversion unit 21, and the control unit 10 to be described later are equivalent to an example of a “power detection unit”, and are configured to detect power that is supplied to the second load 82 side on the path between the power storage unit 92 and the second load 82 (specifically, the first conductive path 41).

The current detection unit 33 is provided on the fifth conductive path 45. The current detection unit 33 detects a current flowing through the fifth conductive path 45, and inputs the current as a detected value to the control unit 10.

The control unit 10 is a control circuit for controlling the discharge circuit 20 and the like. When a backup condition is met, the control unit 10 causes the discharge circuit 20 to perform a backup operation. The control unit 10 is configured as a microcomputer, for example, and includes a memory such as a CPU, a ROM or a RAM, an A/D converter, and the like. The control unit 10 can be supplied with power so as to be able to operate using power from the power storage unit 92 even when power supply from the power source unit 91 is interrupted. The control unit 10 receives an instruction signal instructing that power is to be supplied from the external ECU 100 to the first load 81 and the second load 82, and the like.

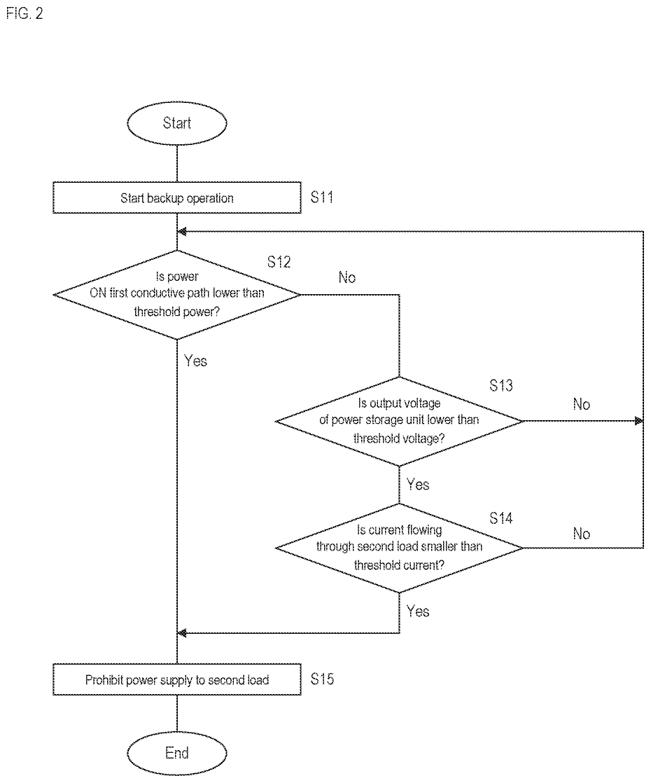

Next, prohibition control of a backup operation that is executed on the second load 82 by the control unit 10 will be described. Note that, for example, when the ignition switch is switched from the off-state to the on-state, the control unit 10 receives an instruction signal from the external ECU 100, and performs control for supplying power to the first load 81 and the second load 82. That is to say, the control unit 10 switches the switches 22, 23, and 46 from the off-state to the on-state, and causes the voltage conversion unit 21 to perform a discharge operation of causing a discharge current to flow from the second conductive path 42 to the first conductive path 41. The control unit 10 continuously monitors whether or not power supply from the power source unit 91 is in a failure state, based on an input signal from the voltage detection unit 31. That is to say, the control unit 10 determines whether or not the voltage that is applied to the third conductive path 43 (the voltage of the high-potential terminal of the power source unit 91) is lower than a reference voltage value. When a backup condition is met, the control unit 10 starts control shown in FIG. 2. The backup condition is power supply from the power source unit 91 entering a failure state and the voltage that is applied to the third conductive path 43 being lower than the reference voltage value.

In step S11, the control unit 10 performs control for starting a backup operation (control for causing the discharge circuit 20 to perform a backup operation). That is to say, the control unit 10 switches the switch 46 from the on-state to the off-state, and causes the voltage conversion unit 21 to perform a discharge operation of causing a discharge current to flow from the first conductive path 41 to the second conductive path 42. Accordingly, power is supplied from the power storage unit 92 to the first load 81 and the second load 82.

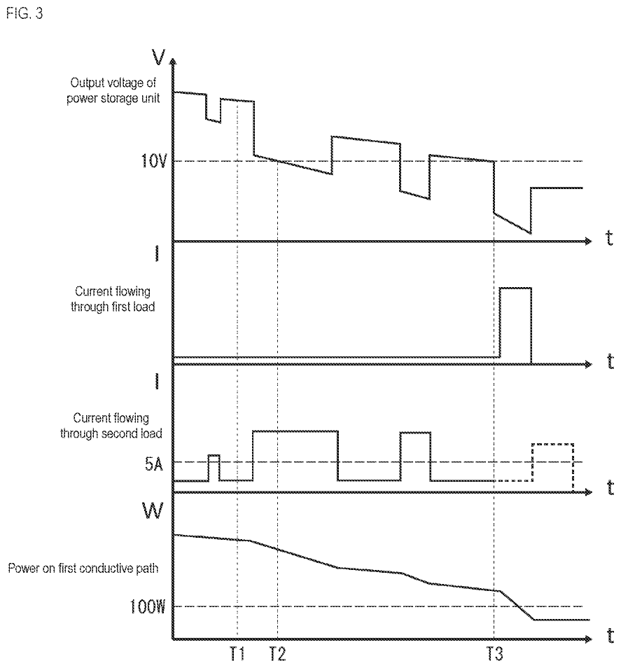

Next, in step S12, the control unit 10 determines whether or not power on the first conductive path 41 is lower than threshold power (for example, 100 W). The threshold power is set, for example, as a threshold value that is higher than power at which the first load 81 can operate as a result of power being supplied from the power storage unit 92 to the first load 81, by a predetermined value (for example, 5 W). The control unit 10 calculates power on the first conductive path 41 based on an output voltage of the power storage unit 92 detected by the voltage detection unit 32 and a current flowing through the first conductive path 41 detected by the current detection circuit of the voltage conversion unit 21. In step S12, if it is determined that the power on the first conductive path 41 is not lower than the threshold power, the control unit 10 advances the procedure to “No”, and performs step S13 to be described later. At times T1, T2, and T3 in the timing chart in FIG. 3 showing time changes in detected values detected by an in-vehicle power source control apparatus, for example, power on the first conductive path 41 is higher than or equal to the threshold power (not lower than the threshold power), and thus the procedure advances to “No” in step S12.

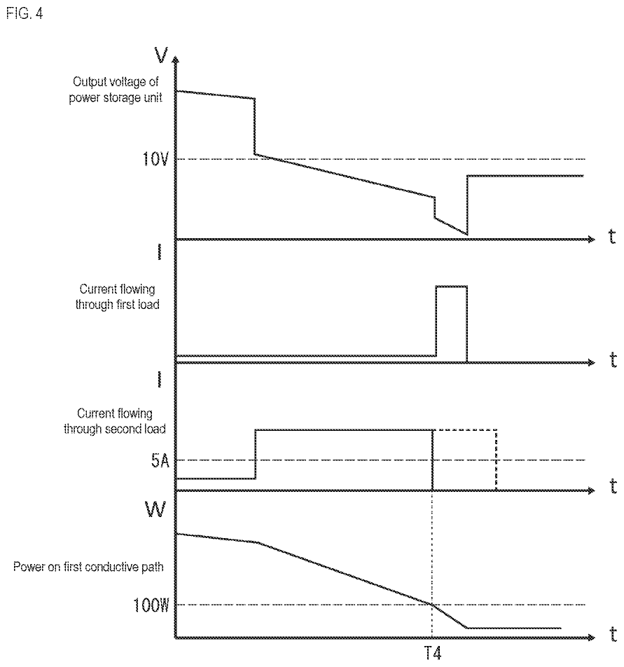

On the other hand, if it is determined in step S12 that the power on the first conductive path 41 is lower than the threshold power, the control unit 10 advances the procedure to “Yes”, and performs step S15. At time T4 in the timing chart in FIG. 4 showing time changes in detection values that are different from those in FIG. 3, for example, the power on the first conductive path 41 is lower than the threshold power, and thus the procedure advances to “Yes” in step S12. In step S15, the control unit 10 prohibits the backup operation (power supply to the second load 82). Accordingly, the control unit 10 switches the switch 23 from the on-state to the off-state. Accordingly, the control apparatus 3 can secure, in the power storage unit 92, power that can be supplied in order to operate the first load 81. The control unit 10 maintains the prohibited state in which the backup operation is prohibited from being performed on the second load 82, during a period from when a backup operation is prohibited from being performed on the second load 82 until when the backup operation ends (until a stop instruction is obtained from the external ECU 100). The prohibited state of the backup operation is a state that occurs based on predetermined control that is performed by the control unit 10. When a prohibition end condition is met (when the backup operation ends, when ignition is turned off, etc.), the prohibited state of the backup operation ends in response to an instruction from the control unit 10. After the processing in step S15, the control unit 10 ends the control in FIG. 2.

In step S13, the control unit 10 determines whether or not the output voltage of the power storage unit 92 is lower than a threshold voltage (for example, 10 V). The threshold voltage is set, for example, as a threshold value at which the first load 81 can operate when a voltage that is lower than the threshold voltage by a predetermined value can be output from the power storage unit 92. If it is determined in step S13 that the output voltage of the power storage unit 92 is higher than or equal to the threshold voltage, the control unit 10 advances the procedure to “No”, and performs the processing in step S12 again. At time T1 in the timing chart shown in FIG. 3, for example, the output voltage of the power storage unit 92 is higher than or equal to the threshold voltage, and thus the procedure advances to No in step S13. If it is determined that the output voltage of the power storage unit 92 is higher than or equal to the threshold voltage, the control unit 10 continues the backup operation, determining that the power storage unit 92 is capable of supplying power for operating the first load 81. On the other hand, if it is determined in step S13 that the output voltage of the power storage unit 92 is lower than the threshold voltage, the control unit 10 advances the procedure to “Yes”, and performs the processing in step S14. At times T2 and T3 in the timing chart shown in FIG. 3, for example, the output voltage of the power storage unit 92 is lower than the threshold voltage, and thus the procedure advances to Yes in step S13.

The control unit 10 determines in step S14 whether or not a current flowing through the second conductive path 42 is smaller than a threshold current (for example, 5 A). The threshold current is set, for example, as the magnitude of a current that is detected by the current detection unit 33 when the second load 82 is not operating in a state where a current can be supplied to the second load 82 (the switch 23 is on). If it is determined in step S14 that a current flowing through the second conductive path 42 is not smaller than the threshold current, the control unit 10 advances the procedure to “No”, and performs the processing in step S12 again. If it is determined that a current flowing through the second conductive path 42 is not smaller than the threshold current, it can be inferred that the accuracy of the power supply ability of the power storage unit 92 detected in step S13 is low. Therefore, the control unit 10 continues the backup operation, determining that the power storage unit 92 is capable of supplying power for operating the first load 81.

On the other hand, if it is determined in step S14 that a current flowing through the second conductive path 42 is smaller than the threshold current, the control unit 10 advances the procedure to “Yes”, and performs the processing in step S15. At time T3 in the timing chart shown in FIG. 3, for example, the current flowing through the second conductive path 42 is smaller than the threshold current, and thus the procedure advances to “Yes”. When the current flowing through the second conductive path 42 is smaller than the threshold current, it is inferred that power supply to the second load 82 is in a stopped state or a predetermined decrease state. The stopped state refers to a state where the second load 82 is not operating based on control that is performed by the external ECU 100 or the like, and power is not supplied to the second load 82. Specifically, the stopped state is a state where a current that is supplied to the second load 82 (a current that is detected by the current detection unit 33) is 0. The predetermined decrease state refers to a state where power supply to the second load 82 is relatively low. The predetermined decrease state is, for example, a state where the current that is supplied to the second load 82 (the current that is detected by the current detection unit 33) is higher than 0 and is smaller than the threshold current. The predetermined decrease state occurs when a dark current flows through the second load 82, when the second load 82 operates at low power consumption, and the like. At time T3 in FIG. 3, the current flowing through the second conductive path 42 is higher than 0 and smaller than the threshold current, and thus power supply to the second load 82 is in a predetermined decrease state.

In step S15, the control unit 10 prohibits the backup operation (power supply) from being performed on the second load 82, and ends the control in FIG. 2. The control unit 10 maintains the prohibited state in which the backup operation is prohibited from being performed on the second load 82 until the backup operation ends (until a stop instruction is obtained from the external ECU 100), for example. When a current flowing through the second conductive path 42 is smaller than the threshold current, it can be inferred that the accuracy of the power supply ability of the power storage unit 92 detected in step S13 is high. Therefore, the control unit 10 prohibits the backup operation, determining that the power storage unit 92 is not capable of supplying power for operating the first load 81. In this manner, after the backup operation is started, when the current that is supplied to the second load 82 is smaller than the threshold current, and the output voltage of the power storage unit 92 falls below the threshold voltage, the control unit 10 prohibits the backup operation from being performed on the second load 82.

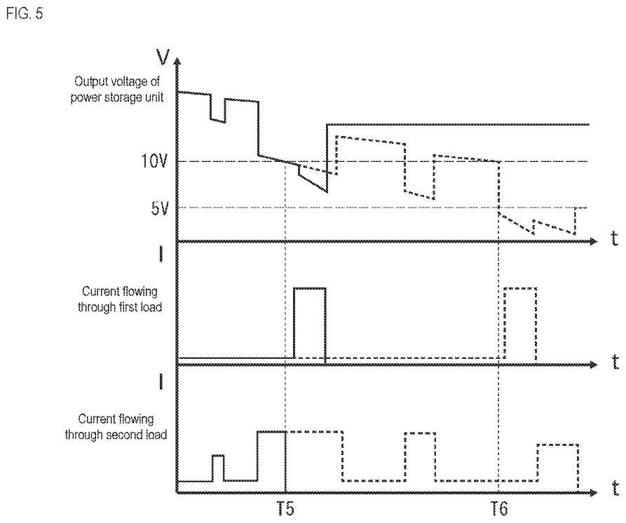

FIG. 5 is a timing chart showing time changes in detected values detected by a conventional in-vehicle power source control apparatus. A conventional in-vehicle power source control apparatus is configured to determine whether or not an output voltage of a power storage unit is lower than threshold power regardless of whether or not the second load 82 is operating. Therefore, at time T5 in the waveform indicated by a solid line in FIG. 5, although the second load 82 is operating, the output voltage of the power storage unit is lower than the threshold power, and thus a backup operation is prohibited from being performed on the second load 82. Accordingly, although the power storage unit 92 has a sufficient power supply ability for the second load 82 to operate as indicated by the waveform indicated by the broken line, the second load 82 cannot be operated. On the other hand, at time T6 on the waveform indicated by the broken line in FIG. 5, the output voltage of the power storage unit 92 is lower than the threshold power in a state where the second load 82 is not operating, and thus the control apparatus 3 of the present disclosure prohibits the backup operation from being performed on the second load 82. Accordingly, the control unit 10 can set a period during which the second load 82 can operate for longer than a conventional configuration, and can prevent the backup operation from being excessively prohibited.

The control apparatus 3 of the present disclosure has the following effects, for example.

The control apparatus 3 can more accurately recognize the power supply ability of the power storage unit 92 by comparing the output voltage of the power storage unit 92 obtained in a state where operation of the second load 82 has little or no influence with a threshold voltage. That is to say, the control apparatus 3 can accurately recognize the power supply ability of the power storage unit 92 in a state where a voltage decrease that occurs in the internal resistance of the power storage unit 92 due to the second load 82 operating has no influence. When there is a steady decline in the power supply ability of the power storage unit 92, the control unit 10 can prohibit the backup operation, and thus suppress a further decline, and save the ability to supply power to the first load 81. On the other hand, a configuration can be adopted in which, even when the voltage temporarily decreases, the control unit 10 does not prohibit the backup operation provided that the voltage does not decrease when the second load 82 is in a stopped state. Accordingly, the control unit 10 can prevent the backup operation from being excessively prohibited.

A power detection unit that detects power that is supplied to the second load 82 side is provided on a path (the first conductive path 41) between the power storage unit 92 and the second load 82. When power that is detected by the power detection unit falls below a threshold power after the backup operation is started, the control unit 10 prohibits the backup operation from being performed on the second load 82.

With such a configuration, the control unit 10 can recognize that power can be supplied to the second load 82 side by the power storage unit 92, by comparing power that is detected by the power detection unit with the threshold power. Accordingly, even when power supply to the second load 82 is not in a stopped state or a predetermined decrease state, and it is not possible to recognize the output voltage of the power storage unit 92, the control unit 10 can detect a decline state of the power supply ability from the power storage unit 92 to the second load 82 side. When there is a steady decline in the power supply ability of the power storage unit 92, the control unit 10 can prohibit the backup operation, and thus suppress a further decline, and save the power supply ability for the first load 81. On the other hand, by adopting a configuration in which the backup operation is not prohibited if the power supply ability of the power storage unit 92 is secured, the control unit 10 can prevent the backup operation from being excessively prohibited.

A current detection unit 33 that detects a current flowing through the second load 82 is provided. When a current that is detected by the current detection unit 33 is smaller than a threshold current, and an output voltage of the power storage unit 92 falls below a threshold voltage, the control unit 10 prohibits the backup operation from being performed on the second load 82.

With such a configuration, when a current flowing through the second load 82 is smaller than a threshold current, the control unit 10 can infer that the second load 82 is in a stopped state or a predetermined decrease state. Therefore, when a current that is detected by the current detection unit 33 is smaller than the threshold current, the control unit 10 compares the output voltage of the power storage unit 92 with the threshold voltage. Moreover, the control unit 10 can more accurately recognize the power supply ability of the power storage unit 92 in a state where operation of the second load 82 has little or no influence.

After the backup operation is started and the backup operation is prohibited from being performed on the second load 82, the control unit 10 maintains a prohibited state until the backup operation ends.

With such a configuration, the control unit 10 prohibits the backup operation from being performed on the second load 82, and thus does not need to supply power to the second load 82 any longer. Therefore, in place of not supplying power after prohibiting the backup operation from being performed on the second load 82, the control unit 10 can increase the power supply ability before the backup operation is prohibited from being performed on the second load 82.

### Other Embodiments of Present Disclosure

The embodiment that has been disclosed is to be considered as illustrative and non-limiting in all aspects. The following embodiment can be adopted, for example.

In the above embodiment, in step S12, the control unit 10 is configured to calculate power on the first conductive path 41 based on a voltage detected by the voltage detection unit 32 and a current detected by the electric current detection circuit of the voltage conversion unit 21. However, the control unit 10 may be configured to detect power on a conductive path other than the first conductive path 41. The voltage conversion unit 21 may include, for example, a second current detection circuit that detects a current flowing through the second conductive path 42 to the second load 82 side and a second voltage detection circuit that detects a voltage that is applied to the second conductive path 42. Moreover, the control unit 10 may be configured to calculate power on the second conductive path 42 based on a voltage detected by the second voltage detection circuit and a current detected by a second current detection circuit.

In the above embodiment, in step S15 in FIG. 2, until the backup operation ends (a stop instruction is obtained from the external ECU 100), the control unit 10 maintains the prohibited state in which the backup operation is prohibited from being performed on the second load 82. However, the control unit 10 may also be configured to maintain the prohibited state in which the backup operation is prohibited from being performed on the second load 82 until another timing. The control unit 10 may be configured to maintain the prohibited state until the first load 81 completes an operation, for example.

In the above embodiment, an electric double layer capacitor (EDLC) is used for the power storage unit 92, but there is no limitation to this configuration, and other power storage means such as a lithium ion battery, a lithium ion capacitor, a nickel-hydrogen charging battery may also be used. In addition, the number of power storage means constituting the power storage unit 92 is not limited to one, and the power storage unit 92 may be constituted by a plurality of power storage means.

In the above embodiment, the vehicle power source system 1 includes the first load 81 and the second load 82, but may also include another load.

1. An in-vehicle power source control apparatus that controls an in-vehicle power source system that includes a power storage unit and a power source unit configured to supply power to a first load and a second load,
the in-vehicle power source control apparatus comprising:
a discharge circuit configured to perform a backup operation of supplying power from the power storage unit to the first load and the second load;
a control unit configured to cause the discharge circuit to perform the backup operation when a backup condition is met; and
a voltage detection unit configured to detect an output voltage of the power storage unit,
wherein, when an output voltage of the power storage unit falls below a threshold voltage while power supply to the second load is in a stopped state or a predetermined decrease state after the backup operation is started, the control unit prohibits the backup operation from being performed on the second load.

2. An in-vehicle power source control apparatus according to claim 1, further comprising
a power detection unit configured to detect power that is supplied to the second load side, and provided on a path between the power storage unit and the second load,
wherein, when power that is detected by the power detection unit falls below a threshold power after the backup operation is started, the control unit prohibits the backup operation from being performed on the second load.

3. An in-vehicle power source control apparatus according to claim 1, further comprising
a current detection unit configured to detect a current flowing through the second load,
wherein, when a current that is detected by the current detection unit is smaller than a threshold current, and the output voltage of the power storage unit falls below a threshold voltage, the control unit prohibits the backup operation from being performed on the second load.

4. An in-vehicle power source control apparatus according to claim 1, wherein, after the backup operation is started and the backup operation is prohibited from being performed on the second load, the control unit maintains a prohibited state until the backup operation ends.

5. An in-vehicle power source apparatus comprising:
the in-vehicle power source control apparatus according to claim 1; and
the power storage unit.

6. An in-vehicle power source control apparatus according to claim 2, further comprising:
a current detection unit configured to detect a current flowing through the second load,
wherein, when a current that is detected by the current detection unit is smaller than a threshold current, and the output voltage of the power storage unit falls below a threshold voltage, the control unit prohibits the backup operation from being performed on the second load.

7. An in-vehicle power source control apparatus according to claim 2, wherein, after the backup operation is started and the backup operation is prohibited from being performed on the second load, the control unit maintains a prohibited state until the backup operation ends.

8. An in-vehicle power source control apparatus according to claim 3, wherein, after the backup operation is started and the backup operation is prohibited from being performed on the second load, the control unit maintains a prohibited state until the backup operation ends.

9. The in-vehicle power source apparatus according to claim 5, further comprising:
a power detection unit configured to detect power that is supplied to the second load side, and provided on a path between the power storage unit and the second load,
wherein, when power that is detected by the power detection unit falls below a threshold power after the backup operation is started, the control unit prohibits the backup operation from being performed on the second load.

10. The in-vehicle power source apparatus according to claim 5, further comprising:
a current detection unit configured to detect a current flowing through the second load,
wherein, when a current that is detected by the current detection unit is smaller than a threshold current, and the output voltage of the power storage unit falls below a threshold voltage, the control unit prohibits the backup operation from being performed on the second load.

11. The in-vehicle power source apparatus according to claim 5, wherein, after the backup operation is started and the backup operation is prohibited from being performed on the second load, the control unit maintains a prohibited state until the backup operation ends.
